(19) United States
(12) Patent Application Publication
(10) Pub. No.: US 2018/0297038 A1
(43) Pub. Date: Oct. 18, 2018

(54) Portable Rolling Shredder Unit

(71) Applicant: Regis Costello, Tukwila, WA (US)

(72) Inventor: Regis Costello, Tukwila, WA (US)

(21) Appl. No.: 15/954,013

(22) Filed: Apr. 16, 2018

Related U.S. Application Data
(60) Provisional application No. 62/485,733, filed on Apr. 14, 2017.

(51) Int. Cl. B02C 21/02; B02C 18/00

(52) U.S. Cl. CPC B02C 21/02; B02C 2018/0046; B02C 2018/0038; B02C 18/0007

(57) ABSTRACT

A portable shredder unit that includes a lightweight housing with a large interior cavity divided into a battery storage cavity and a collection cavity. Mounted on lid of the housing is a high capacity paper shredder component. Located inside the battery storage cavity is at least one 12 VDC rechargeable battery. The battery is connected to an inverter configured to convert the 12 VDC current into 110 VAC current required by the shredder component. Mounted on one end of the housing is a pair of wheels. Mounted on the opposite end of the housing is a pivoting or retractable handle that enables the unit to be pulled across a flat surface. The unit includes a control panel with a mode switch that controls the electricity source to the shredder component. An electrical cable is mounted on a wire retracting mechanism located inside the housing or lid. An optional battery charger is, also provided.

This utility patent application is based on and claims the filing date benefit of U.S. Provisional Patent Application (Application No. 62/485,733) filed on Apr. 14, 2017.

Notice is given that this patent document contains original material subject to copyright protection. The copyright owner has no objection to the facsimile or digital download reproduction of all or part of the patent document, but otherwise reserves all copyrights.

### BACKGROUND OF THE INVENTION

### 1. Field of the Invention

This invention pertains to paper shredders, and more particular to portable paper shredders than can be easily transported to different locations and used to shred paper, credit cards and other important document immediately at the location.

### 2. Description of the Related Art

Retirement centers are housing complexes designed for older adults who can care for themselves but need assistance with meals, social activities and transportation. Tenants typically reside in their own 1 to 2-bedroom apartments and individually purchase telephone and cable television services. Other services, such as water, electricity gas, mail services and house cleaning services are usually provided by the retirement center employees.

Mail and packages sent to residents in the retirement center are delivered to a central post office, sorted and then placed into each resident's locked mail box. Because the residents are older adults, the mail and packages they receive often contain retirement checks, bank statements, medical records, estate documents; or other confidential documents and must be disposed of properly. Unfortunately, older adults either don't have paper shredders or don't have the visual capabilities or memories to operate a shredder. Therefore, important confidential papers inadvertently deposited in the trash. Shredding companies that pickup confidential papers and agree to destroy them later at a remote location are also unsatisfactory because the destruction of these papers cannot be verified by the resident.

What is needed is a portable shredder that can be easily transported to each individual apartment and used to shred confidential materials immediately in front of the resident. What is needed is a portable shredder that operates on either on a battery or on a 110 volt electrical outlet.

### SUMMARY OF THE INVENTION

Disclosed herein are two embodiments of a portable rolling shredder unit that includes a lightweight housing with a large interior cavity divided into a battery storage cavity and a collection cavity. Mounted on the housing's lid or located inside the housing is a high capacity electric shredder.

Located inside the housing's battery storage cavity is a rechargeable battery. The unit is designed so the shredder may run off an external 110 VAC power source or run off a rechargeable battery. An inverter is provided that inverts the 12 VDC electric current from the battery into a 110 VAC electric current for use by the shredder. A battery charger is also provided used to recharge the rechargeable battery when desired. The unit also includes a control panel with a mode switch that operator uses to control the source of electricity to the shredder and to setup the unit for battery charging.

The unit includes a long extension cord stored in an automatically rewind reel. The end of the extension cord is connected to a GFCI electrical outlet mounted on the side of the housing or inside the housing. The GFCI electrical outlet is connected to power inlet connectors on a control panel that includes a three-position mode switch that the operates manually operates to run the shredder motor from an 110 VAC power source, a 12 VDC power source or activate a recharging unit to recharge the 12 VDC battery. The control panel also includes power outlet connectors are connected to a cable that connects to the shredder.

The inverter is configured to convert 12 VDC from the rechargeable battery into 110 VAC. The inverter includes at least one female electrical outlet, an external switch, and positive and negative charging cables configured to connect to a 12-volt VDC rechargeable battery. The inverter may be hardwired directly to the control panel or it may include a power cable that manually connects to a female outlet plug on the GFCI electrical outlet.

The battery charger includes a positive and negative charging cables that connect to the rechargeable battery. The battery charger includes a power cable that manually connects to a female outlet plug on the GFCI electrical outlet.

In a first embodiment, the housing 12 is smaller than the housing used on the second embodiment. In the first embodiment, the inverter and the battery charger are mounted in an ancillary box that attaches to the outside surface of the housing.

Each housing is mounted on at least one pair of wheel that enable the housing to be manually moved over a flat surface. Each housing also includes an elongated handle that enables the housing to be manually lifted or tilted diagonally like a two wheel hand truck. In one embodiment, the handle may be pivotally attached at one end to the housing or it may be retractable and slide into the housing or lid.

In both embodiments, an optional single or dual electrical power plugin may also be mounted on the side of the housing or the lid that connects to a standard male plug on an extension cord or a second electrical appliance, such as a vacuum cleaner.

In the preferred embodiment, the shredder component is mounted in the lid with its discharge shoot located over the collection cavity. An optional transversely aligned partition may be placed inside the housing to separate the battery cavity from the collection cavity. The partition is configured to prevent shredded material from falling into the battery cavity.

In one embodiment, a plastic collection bin may be placed in the collection cavity to collect shredded material. In another embodiment, an optional plastic bag may be expanded and hung inside the collection cavity so shredded material falls directly therein. In another embodiment, the shredder component is located inside the collection cavity formed in the housing. An optional slot may be formed on the lid directly over the feed opening on the shredder so that paper may be fed into the shredder when the lid is closed on the housing.

### DESCRIPTION OF THE DRAWINGS

FIG. 1 is a top perspective view of a portable, rolling shredder unit.

FIG. 2 is a side elevational view of the shredder unit shown in FIG. 1 showing the lid being removed from the housing and showing the elongated handle pivotally attached and rotated diagonally and used to pull the shredder unit over a flat surface.

FIG. 3 is a top plan view of the shredder unit shown in FIG. 2 with the elongated handle vertically aligned in storage configuration.

FIG. 4 is a top plan view of the shredder unit shown in FIG. 2 showing the lid removed so that shredded material may be removed from the collection cavity.

FIG. 5 is a top perspective view of a second embodiment of the portable shredder unit that uses a larger housing configured to hold the inverter and includes a larger waste cavity.

FIG. 6 is a top plan view of the portable shredder unit shown in FIG. 5.

FIG. 7 is an end perspective view of the shredder unit shown in FIGS. 5 and 6.

FIG. 8 is a perspective view showing the opposite end of the shredder unit shown in FIG. 7.

FIG. 9 is a top plan view of the shredder shown in FIG. 1 with the lid in an open position and showing the contents of the housing.

FIG. 10 is a partial top plan view of the two 12 DC volt batteries.

FIG. 11 is a side elevational view of the lid disposed in an open position over the housing showing the location of the electric shredder unit and the retractable windup spool that holds a long connector cord.

FIG. 12 is a partial top perspective showing the lid in an open configuration and showing the shredder component located inside the collection cavity formed in the housing with a slot formed on the lid that allows an operator to feed material into the feed slot opening on the shredder.

FIG. 13 is an illustration showing the electrical components connected together.

### DESCRIPTION OF THE PREFERRED EMBODIMENT(S)

A portable rolling shredder unit 10 that includes a six-sided, lightweight housing 12 with a large interior cavity 20 with an optional, transversely aligned, vertical partition 22 that divides the interior cavity 20 into a front battery storage cavity 24 and a rear collection cavity 30. Mounted over the top opening 13 of the housing 12 is a short fixed lid 19 and a moveable long lid 40. In the preferred embodiment, a high capacity electric shredder component 50 with at least one exposed shredder feeding slot 54. The shredder unit 10 is mounted in the lid 40 with its discharge shoot located over the collection cavity 30 so that shredded material falls from the shredder component 50 and into the collection cavity 30. The vertical partition 22 is used to separate the battery storage cavity 24 from the collection cavity 30. In the embodiment shown in the Figs, the housing 12 includes two vertical end walls 14, 16, two vertical side walls 15, 17, a flat floor 18.

Located inside the battery storage cavity 24 is a rechargeable 12 VDC battery 90. In the first embodiment, an ancillary housing 48 is attached to the housing 12 that contains a battery charger 94, an inverter 100, a control panel 160, and a control panel 160. Attached to the control panel 160 is a mode switch 162 discussed further below. Mounted on two side walls 15, 17 and near the first end 14 of the housing 12 is a pair of rear wheels 70. The wheels 70 are attached to the ends of an axle 72 that extends transversely under the floor 18 of the housing 12. U-shaped brackets 74 hold the axle 72 in place in the housing 12. Extending downward from the floor 18 near the second end 16 are a pair of vertical legs 44, 46 that elevate and support the front portion of the housing 12 on a support surface.

Attached to the two ends 14, 16 on the housing 12 are two optional handles 80 thereby allowing the unit 10 to be easily lifted and then pushed or pulled along a flat surface. Mounted on the second end 16 of the housing 12 is an optional pivoting elongated handle 80 that enables the second end 16 to lifted so that the housing 12 is diagonally aligned and may be rolled across a flat support surface, similar to a hand truck or luggage carrier.

The shredder component 50 includes an internal shredder mechanism 60 with an electric motor 62 configured to operate when connected to a 110 AVC electric circuit. The shredder mechanism 60 includes a feeding slot 54, a discharge opening 58, an object sensor 61 that automatically operates the motor 62 for 3 to 5 seconds with an object is detected inside eh slot 54. Mounted on the top surface of the shredder component 50 is a power switch 66 and an optional power ON LED 67. The shredder's electric motor 62 is connected to a mode switch 162 that controls the source of the electricity delivered to the shredder component 50 and controls battery recharging.

The rechargeable battery 90 is a 12 VDC rechargeable battery with at least one positive post 92 and one negative post 93. The positive and negative posts 92, 93 on the rechargeable battery 90 are connected to positive and negative cables 102, 103 that extend from a 12 VDC to 110 VAC power convert inverter 100. During operation, the inverter 100 automatically inverts the 12 VDC circuit to a 110 VAC circuit. The inverter 100 includes a main power switch 104, an optional LED power light 105, an optional USB charging port 106 and at least one female outlet plug 108. The inverter 100 is either directly connected (i.e. hardwired) to the control panel 160 via a direct cable 155 or is manually connected to a GFIC receptacle 140 via a dual male plug cable 150 that plugs into a female outlet plug on the GFCI electrical outlet 140.

The shredder component 50 is mounted on the removable lid 40. During use, the lid 40 is placed over the top opening 13 of the housing 12. The lid 40 with the shredder mechanism 60 are configured to be manually lifted off the housing 12 thereby exposing the collection cavity 30. Shredding material 6 deposited in the collection cavity 30 may be easily removed from the housing 12.

The shredder mechanism 60 is connected to a control panel 110 that includes an electrical source switch 112 that controls which electric source is used to provide 110 VAC current to the shredder motor 62. The control panel 110 may also include an optional battery charging switch 114 that connects to a secondary board 115 that connects the 110 VAC circuit to the control panel 110 or to a battery charger 94. Battery charging switch 114 allows the user to selectively charge the battery 90.

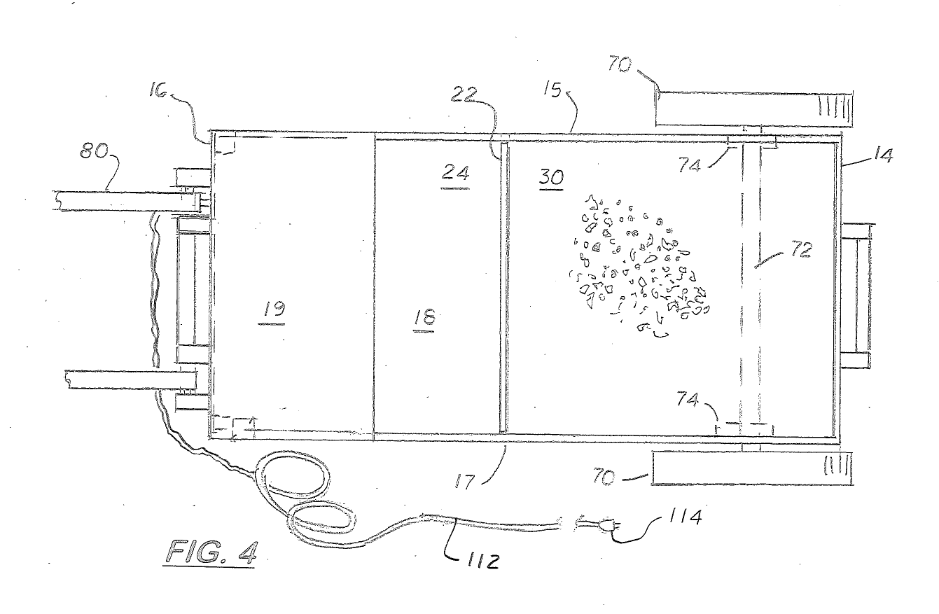

The housing 12 may include a standard, 110 VAC male electrical outlet 160 configured to connect to a 110 VAC standard female end plug connector on an extension cord 170 as shown in FIG. 4. The housing 12 may also include a GFCI breaker 156 for additional protection.

In the first embodiment, the main electric cable 112 extends through an opening formed on the side of the housing 12. Attached to the end of the cable 112 is a standard two or three prongs plug connector 114 configure to plug into a standard 110 VAC electrical outlet 160. The cable 112 is wound onto a built-in automatic rewind real 120 located inside the housing 12.

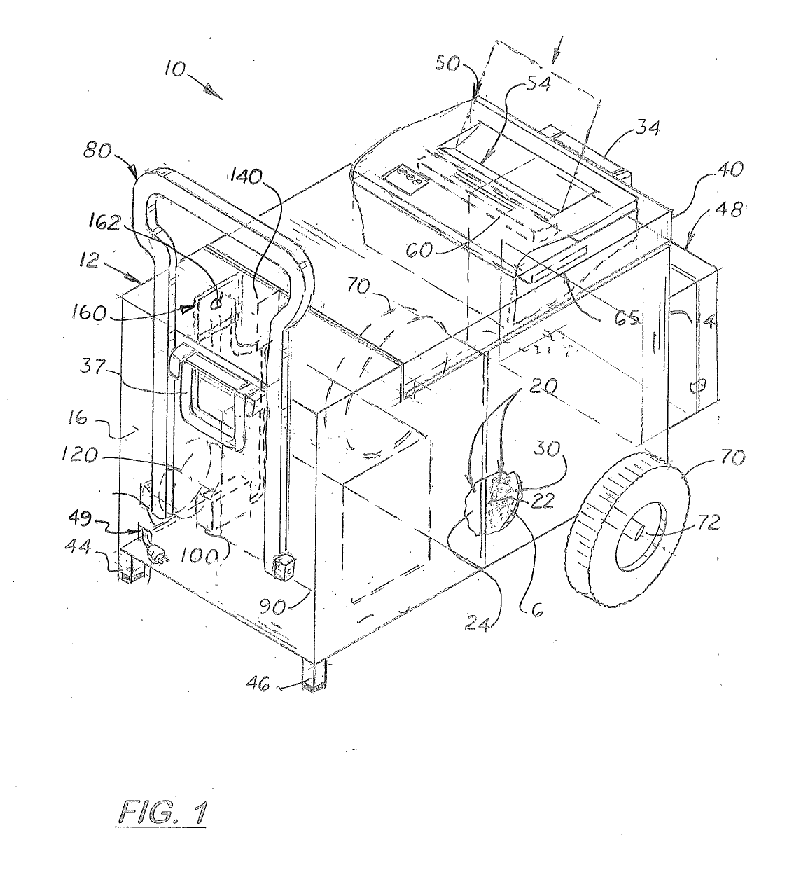

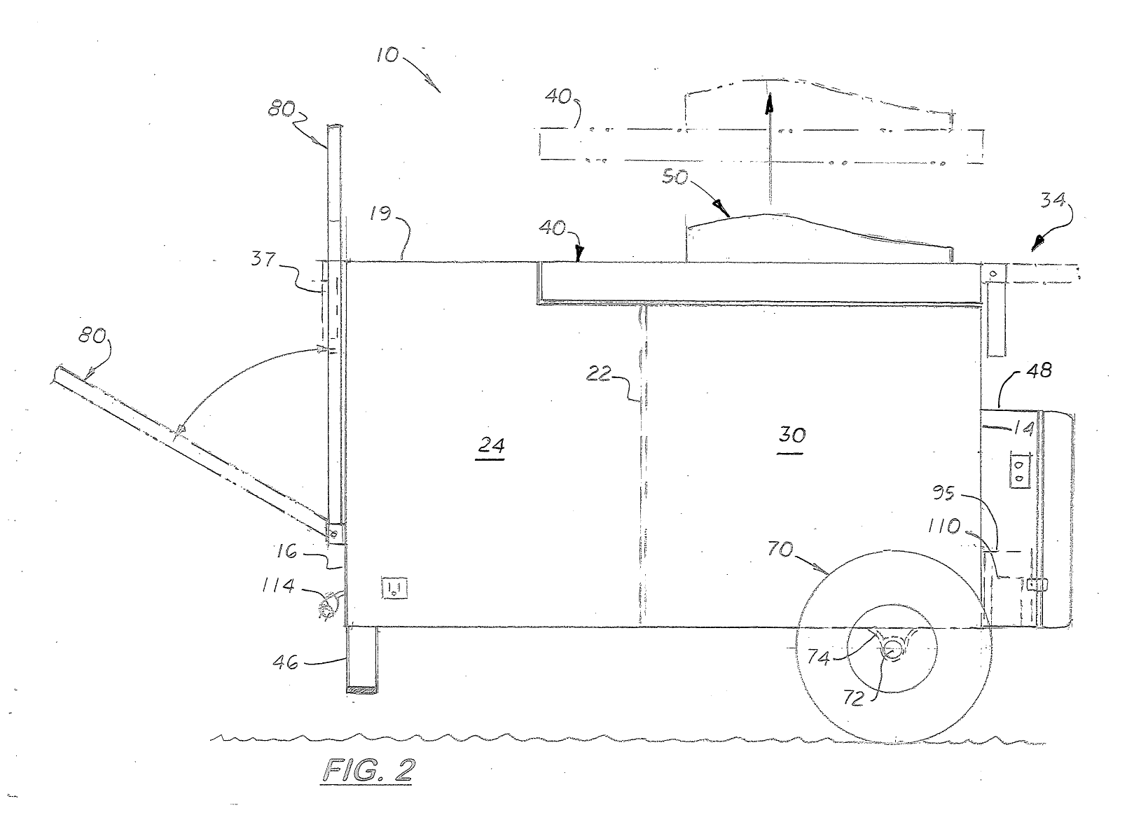

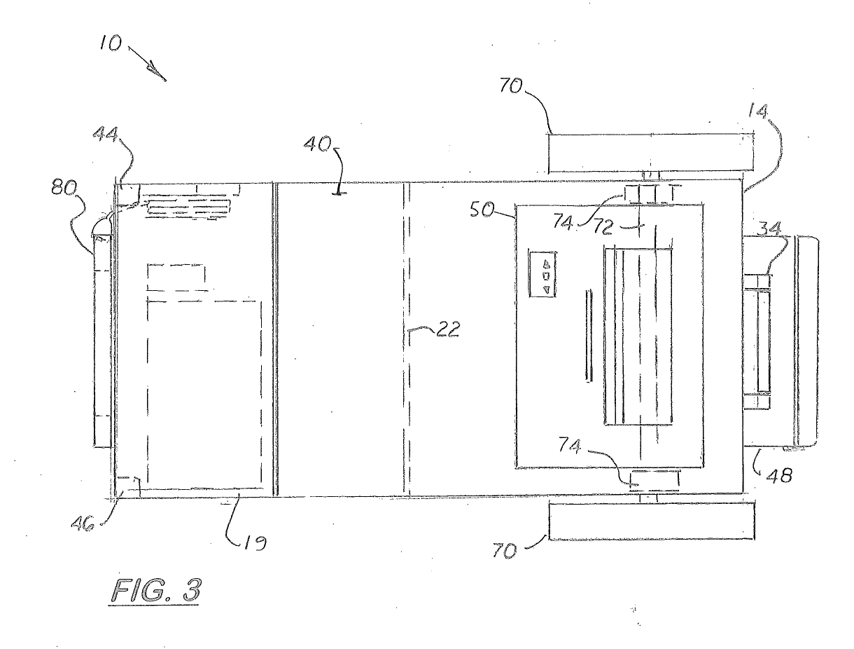

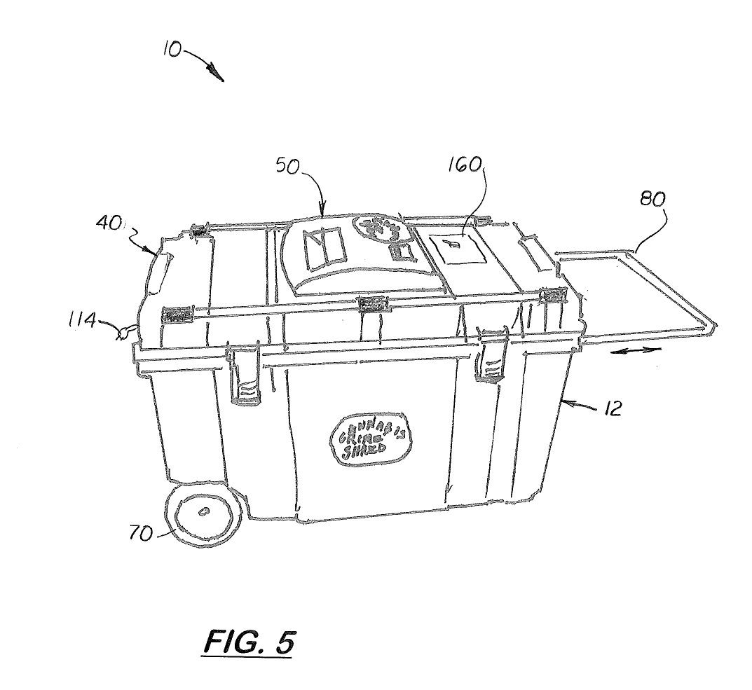

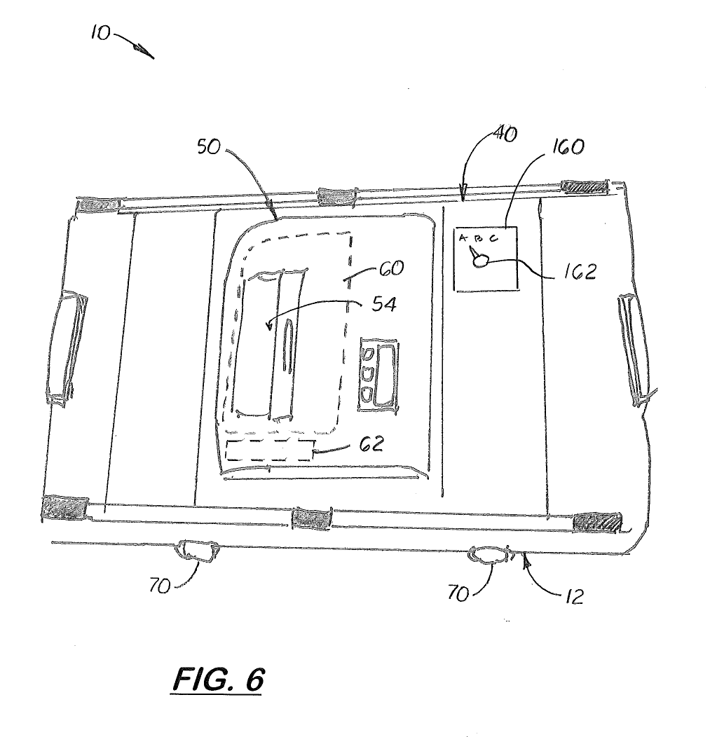

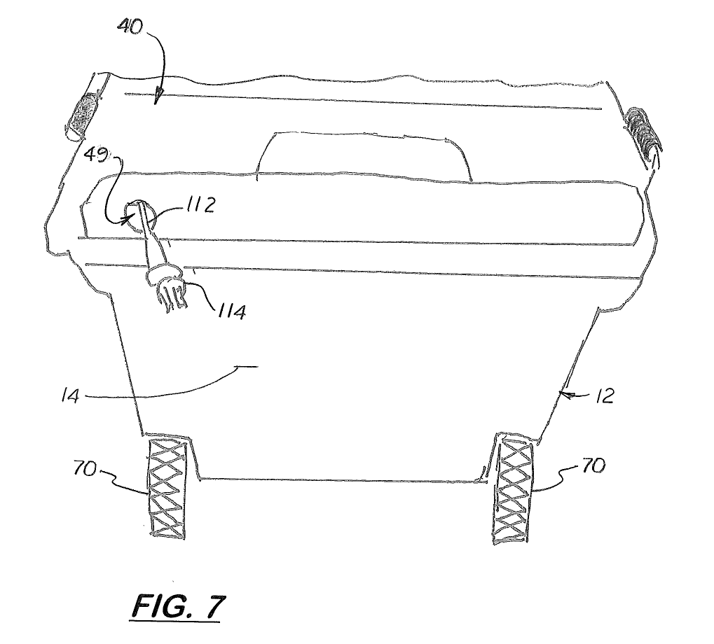

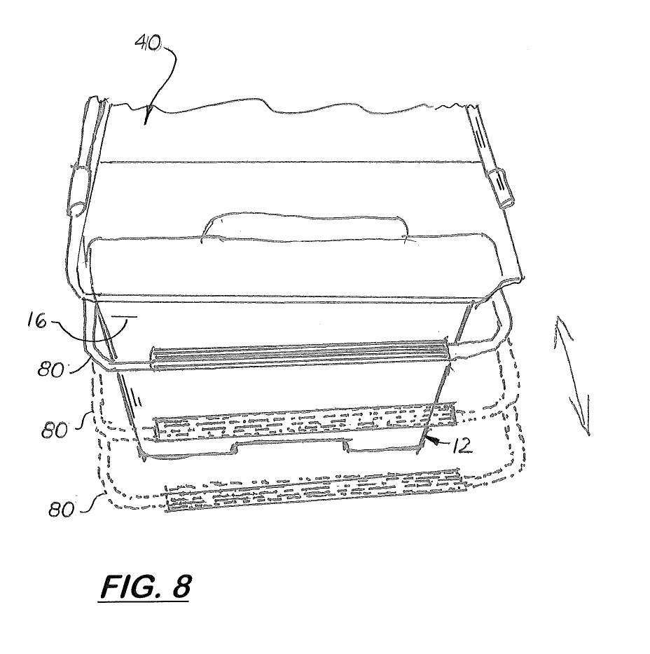

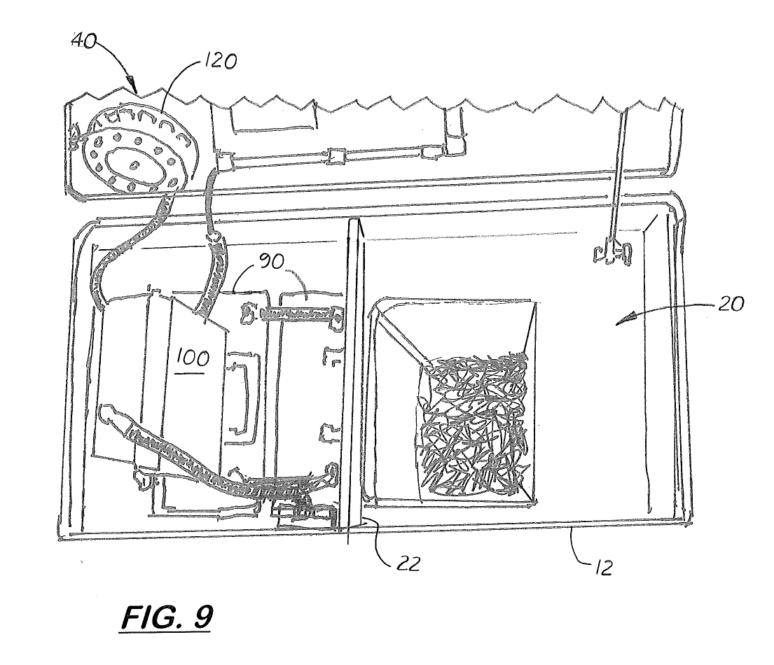

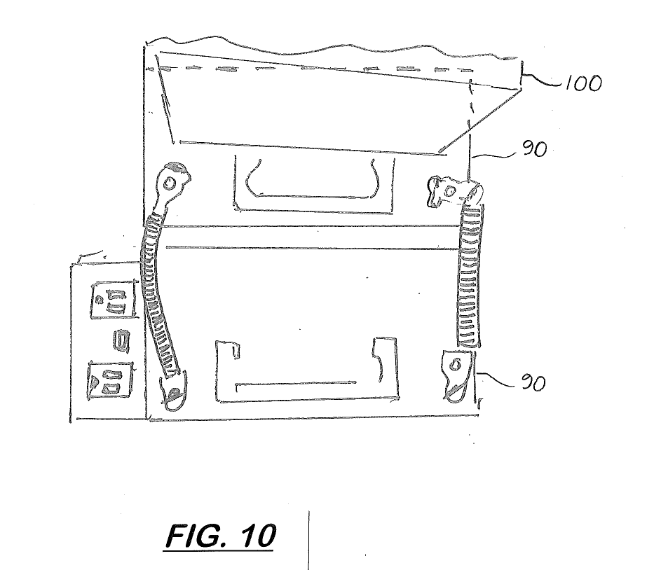

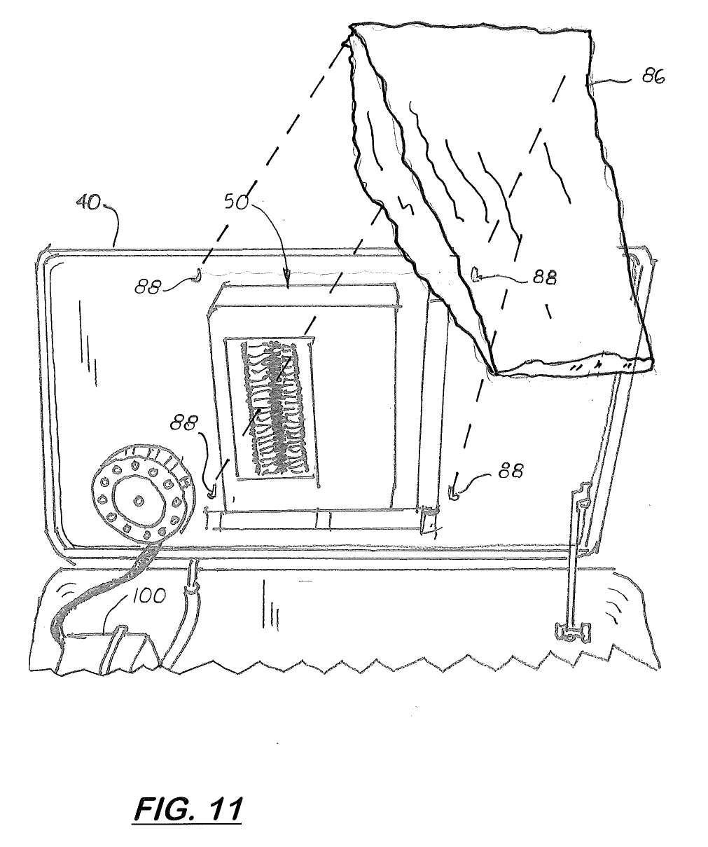

As stated above, the first embodiment of the shredder 10 is shown in FIGS. 1-4 has a housing 12 with a battery cavity 24 configured to house the one rechargeable battery 90. The battery charger, inverter and control panel are located in an ancillary housing. FIGS. 5-11 show a second embodiment of the shredder 10 that uses a larger housing 12 that has a larger battery cavity 24 configured to hold one or more rechargeable batteries, the battery charger, the invertor. The control panel 160 may be mounted inside the housing 12, on the partition, or mounted on an external surface of the housing 12 or lid 40.

In the second embodiment, the fixed lid 19 is eliminated and a modified removable long lid 40 is used that extends the entire length of the housing 12 and is attached via hinges 41 to the top edge of the housing 12. An optional adjustment rod 42 is provided that allows the user to set the lid 40 is a partial or full open position.

In the first embodiment, a rewind reel 120 is mounted inside the housing 12. In the second embodiment, a rewind reel 120 is mounted on the lid 40. The reel 120 is configured to allow the main cable 112 to be pulled from the housing and automatically rewinds main cable 112 into the housing 12 when desired. A wire hole 49 is formed on the end surface of housing 12 or the lid 40 that allows the main cable 112 to extend outside the lid 40.

In the first embodiment, the housing 12 is rectangular with an interior cavity 20 configured to hold approximately 30 gallons. In the second embodiment, the housing 12 is also rectangular with an interior cavity 20 configured to hold approximately 50 gallons.

The batteries are 12 volt DC maintenance free, ventless batteries. The inverter 100 is a 750 watt inventor and has a two female plugins 108 and a USB port 106. The battery charger 94 is a 12 volt DC battery charger connected to a GFCI receptacle 140 enclosed in a single gang electrical box. The shredder component 50 is a Compucessory Heavy Duty Cross-Cut shredder component (Model CCS60060) brand paper shredder component 50 designed to handle up to 30 sheets of paper, credit cards or CD/DVD discs. Other types of brands of shredder components may be used. The handle 80 is made of aluminum and extends approximately 15 to 20 inches from the end of the housing 12.

In one embodiment, a plastic collection bin (not shown) may be placed in the collection cavity 30 to collect shredded material 6. In another embodiment, an optional plastic bag 86 may be expanded and hung inside the collection cavity 30, so shredded material 6 falls directly therein. Hooks 88 may be mounted on the inside surface of the lid 40 that attach the corners of the bag 86 to the lid 40 to keep the bag 86 expanded and vertically aligned.

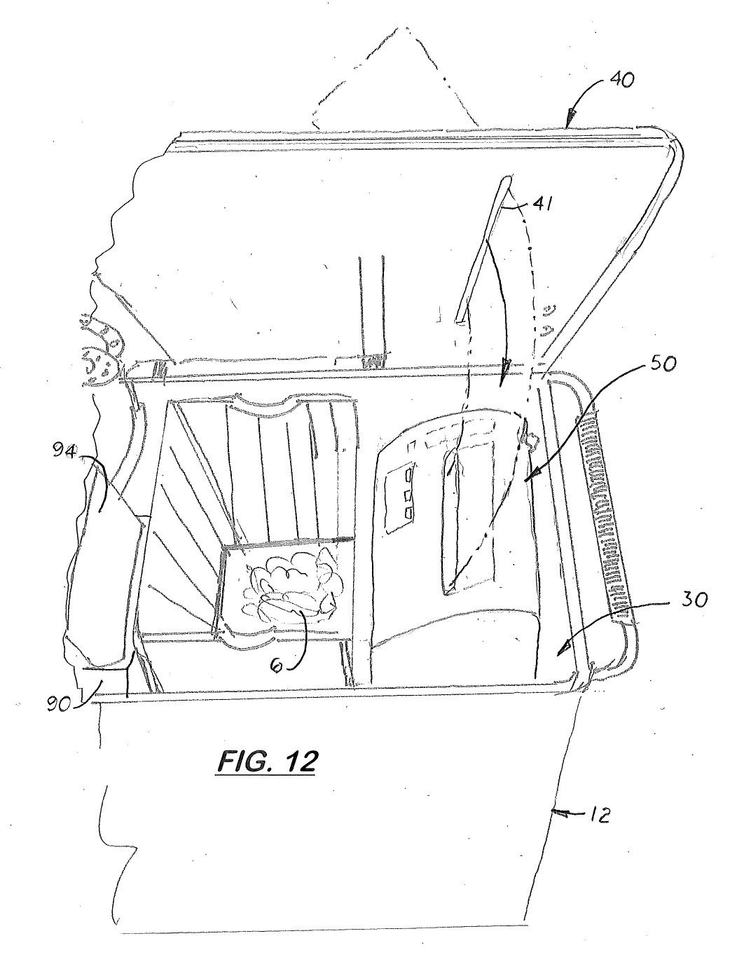

FIG. 12 is a partial top perspective showing the lid 40 in an open configuration and showing the shredder component 50 located inside the collection cavity 30 formed in the housing 12 with a slot 41 formed on the lid 40 that allows an operator to feed material into the feed slot opening on the shredder component 50.

### Operation

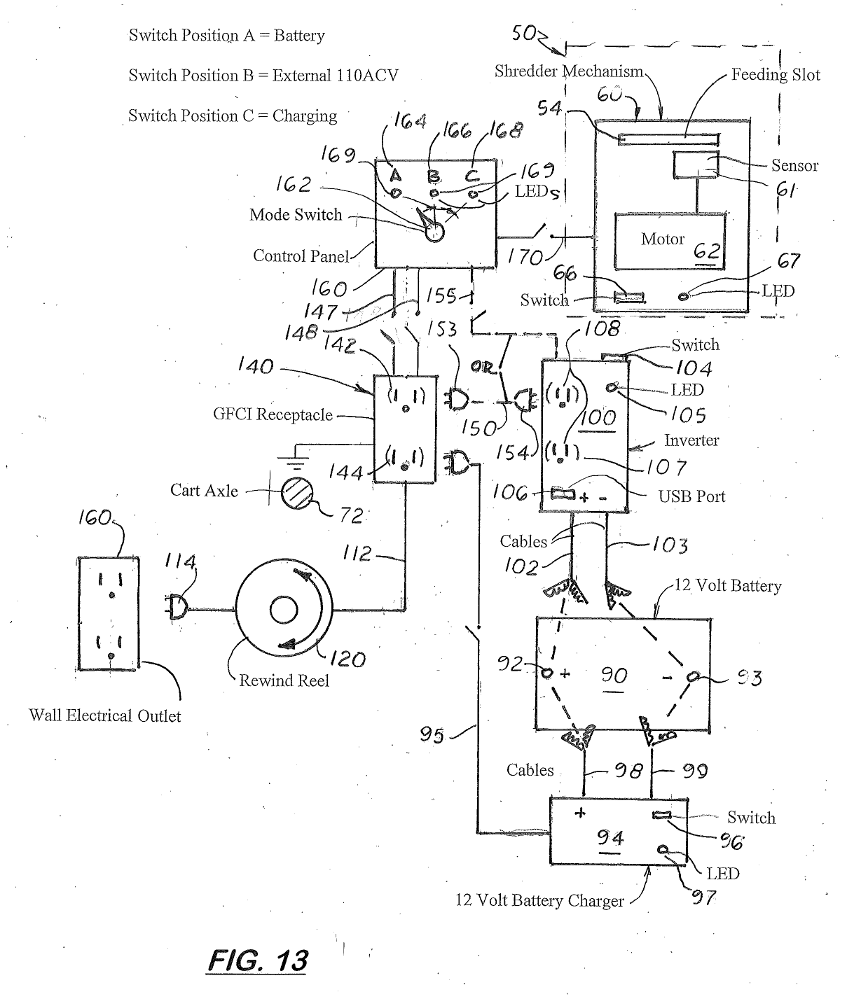

The control panel 160 is connected to the shredder component 50 and to the GFCI electrical outlet and the inverter 100 as shown in FIG. 13. The positive and negative cables 98, 99 on the battery charger 94 are connected to the positive and negative battery posts 92, 93, respectively. The positive and negative cables 102, 103 on the inverter 100 are also connected to the two battery posts 92, 93. The power cable 95 for the battery charger 94 is plugged into a female outlet plug 142 or 144 on the GFCI electrical outlet 140.

The unit 10 may have the inverter 100 directly connected to the control panel 160 via a direct cable 155 or it may be connected via the GFCI electrical outlet 140 via a first cable 147.

The operator then moves the mode switch 162 on the control panel 160 to one or three modes of operation; ‘A’, ‘B’ or ‘C’ positions for battery operation; external 110 VAC operation; or battery charging operation, respectively.

When battery power operation is desired, the power switch 104 on the inverter 100 is moved to the ‘ON’ and the mode switch 162 is moved to the ‘A’ position 166. If the ancillary plug-in cable 150 is used, one male plug 153 is plugged into the female outlet receptacle on the GFCI electrical outlet 140 and the opposite male plug 154 is plugged into the female outlet receptacle 106 on the inverter 100. If the direct cable 155 is used, then electricity from the inverter 100 is delivered directly to the control panel 160. The external power switch 66 on the shredder component 50 is then activated and ready to shred paper, credit cards, or disc deposited into the feeding slot 54. When the plug-in cable 150 is used, electricity from the GFCI electrical outlet 140 is delivered to the control panel 160 via a first cable 147. When the mode switch 162 is moved to the ‘A’ position 164, electricity from the second cable 148, discussed further below is disconnected.

When external 110 VAC operation is desired, then the mode switch 162 is moved to the ‘B’ position 166 and the male plug 114 is plugged into the external 110 VAC electrical outlet 160. The power switch 66 on the shredder component 50 is then activated and ready to shred paper, credit cards, or disc deposited into the feeding slot 54. When the mode switch 162 is moved to the ‘B’ position 166, electricity from the inverter 100 is automatically discontinued. Electricity flows from the GFCI electrical outlet 140 through the second cable 148 to the control panel 160

When battery charging is desired, the mode switch 162 is moved to the ‘C’ position 168. The power switch 96 on the battery charger 94 is then moved to the ‘ON’ position. Electricity from the inverter 100 and from the GFCI electrical outlet 140 are disconnected.

Cables 147, 148 and 170 and power cords 95 may include separate fuses.

In compliance with the statute, the invention described has been described in language more or less specific on structural features. It should be understood, however, that the invention is not limited to the specific features shown, since the means and construction shown comprises the preferred embodiments for putting the invention into effect. The invention is therefore claimed in its forms or modifications within the legitimate and valid scope of the amended claims, appropriately interpreted the doctrine of equivalents.

I claim:

1. A portable shredder unit 10 comprising:
a. a lightweight housing 12 with an interior cavity 20 divided into a battery storage cavity 24 and a collection cavity 30, said housing 12 includes a top opening 13, two opposite ends 14, 16, two opposite side walls 15, 17, and a floor 18;
b. a removable lid 40 attached to said top opening 13 on said housing 12;
c. a high capacity electric shredder component 50 configured to shred paper, said shredder component 50 includes at least one feeding slot opening 54, an electric shredding mechanism 60, and electric motor 62 and an exit discharge opening 65, said shredder component 50 being oriented on said lid 40 so that said feeding slot opening 54 is exposed when the lid 40 is placed over the top opening 13 of said housing 12 and said exit discharge opening 65 is oriented above and over said collection cavity 30 in said housing 12 so that shredded material exiting the exit discharge opening 65 is deposited into said collection cavity 30;
d. at least one pair of wheels 70 attached to said housing 12 near one said end 14;
e. a handle 80 attached to said housing 12;
f. a GFCI receptacle;
g. a 110 VAC main cable with an male electrical plug 114 attached to one end configured to manually plug into an external 110 VAC female plug, and an opposite end being connected to said GFCI receptacle;
h. at least one 12 VDC rechargeable battery 90 located inside said battery storage cavity 24;
i. an inverter 100 configured to convert 12 VDC into 110 VAC, said inverter 100 connected to said rechargeable battery 90 to convert 12 VDC current into 110 VAC, said inverter; and
j. a control panel 160 electrically connected to said shredder, to said inverter and to said GFCI receptacle, said control panel includes a mode switch 162 configured to allow an operator to select the source of electricity either from said GFCI receptacle 140 when said main cable 112 is connected to an external 110 VAC female plug 160 or from said inverter 100 when connected to said rechargeable battery 90.

2. The portable shredder unit, as recited in claim 1, wherein said shredder component 50 is mounted on said lid 40

3. The portable shredder unit, as recited in claim 1, wherein said handle 80 is configured to retract and extend from said housing 12.

4. The portable shredder unit, as recited in claim 1, further including a reel rewind spool 120 configured to automatically rewind said main cable 112 onto said spool 120 and allow said main cable 112 to be selectively unwound therefrom.

5. The portable shredder unit, as recited in claim 3, wherein said reel rewind spool 120 is located in said lid 40.

6. The portable shredder unit, as recited in claim 1, further including a vertical partition 22 transversely aligned inside said housing 12 and between the battery shortage cavity 24 and the collection cavity 30.

7. The portable shredder unit, as recited in claim 1, further including a removable plastic bag 86 hung in said collection cavity 30 to collect shredder material from said shredder component 50.

8. The portable shredder unit, as recited in claim 1, wherein said inverter 100 includes at least one female plugin 108 and a dual male plug cable 150 configured to plug into said female plugin 108 in said inverter 100 and plug into said female plugin 144 on said GFCI 140.

9. The portable shredder unit, as recited in claim 1, further including a 12 Volt Battery charger 94 configured to charge said rechargeable battery 90.

10. The portable shredder unit, as recited in claim 9, wherein said battery charger 90 includes a power cable 95 with a male plug that connects to said female electrical plug 144 on said GFCI 140.

11. The portable shredder unit, as recited in claim 10, wherein said mode switch 160 has a third position 168 that indicates said rechargeable battery 90 is being charged by said battery charger 94 and disconnects said shredder component 50 from said external electricity source 160 and disconnects said shredder component 50 from said inverter 100.

12. The portable shredder unit, as recited in claim 3, further including a 12 Volt Battery charger 94 configured to charge said rechargeable battery 90.

13. The portable shredder unit, as recited in claim 12, wherein said battery charger 94 includes a power cable 95 with a male plug that connects to said female electrical plug 144 on said GFCI 140.

14. The portable shredder unit, as recited in claim 13, wherein said mode switch has a third position that indicates said rechargeable battery is being charged by said battery charger 94 and disconnects said shredder component 50 from said external electricity source 160 and disconnects said shredder component 50 from said inverter 100.

15. The portable shredder unit, as recited in claim 12, wherein said inverter 100 includes at least one female plugin 108 and a dual male plug cable 150 configured to plug into said female plugin in said inverter 100 and plug into said female plugin 144 on said GFCI 140.

16. The portable shredder unit, as recited in claim 15, wherein said reel rewind spool 120 is located in said lid 40.

17. The portable shredder unit, as recited in claim 16, further including a vertical partition 22 transversely aligned inside said housing 12 and between the battery shortage cavity 24 and the collection cavity 30.

18. The portable shredder unit, as recited in claim 1, wherein said handle 80 is pivotally attached to the housing 12.

19. The portable shredder unit, as recited in claim 1, wherein said shredder component 50 is located inside said housing 12.

20. The portable shredder unit, as recited in claim 19, further including slot formed on said lid 40 that is aligned over said feed slot on said shredder component 50.
